(19) United States
(12) Patent Application Publication
(10) Pub. No.: US 2010/0206404 A1
(43) Pub. Date: Aug. 19, 2010

(54) BALL CHECK VALVE

(76) Inventors: Stephen Morrison, Utopia (CA); Maria Toth, Markham (CA)

Correspondence Address: SOFER & HAROUN LLP., 317 MADISON AVENUE, SUITE 910, NEW YORK, NY, 10017, US

(21) Appl. No.: 12/522,654

(22) PCT Filed: Jan. 8, 2008
(86) PCT No.: PCT/CA08/00013

§ 371 Date: Apr. 22, 2010

Related U.S. Application Data
(60) Provisional application No. 60/884,032, filed on Jan. 9, 2007.

(51) Int. Cl. F16K 15/04

(52) U.S. Cl. 137/533.15

(57) ABSTRACT

The invention provides an uncomplicated ball check valve whose components can be economically manufactured, assembled and connected and wherein, in accordance with one aspect of the invention, the ball check valve is configured for use as a pressure vessel. In one embodiment of the invention, the ball check valve comprises a housing defining one or more inlet, an outlet and a passageway therebetween. A ball support system is mounted within the housing, wherein one or more balls are supported by the ball support system. The ball support system is configured to allow a ball to close off and open a respective inlet. The housing generally comprises an inlet section which can have one or more inlets, wherein each inlet defines a ball seat sealingly engageable with a ball for sealing the inlet. The housing further comprises a centre section providing adequate space to allow movement of the ball and an outlet section comprising an outlet for transferring the fluid to a subsequent portion of a piping network. The ball support system is configured to guide the movement of each of the one or more balls, wherein the movement of each ball is guided from a first position wherein the ball is proximate to a ball seat located at an inlet and thereby sealing that inlet, to a second position wherein fluid flow through an inlet into the valve is enabled.

### FIELD OF THE INVENTION

The invention relates to check valves and, in particular, to ball check valves.

### BACKGROUND

Many designs for large check valves for use in large-scale industrial applications have been disclosed that can inhibit back flow of fluids. For example, single inlet check valves of U.S. Pat. Nos. 6,510,869, 4,687,023 or 4,501,292 provide guiding means for a ball which can move in and out of the flow passage by allowing the ball to move into or out of a side protrusion in the check valve housing under reversing flow conditions. The protrusion can make these valves large, heavy and complicated. In addition, these types of valve designs can be prone to sediment deposits and can require frequent cleaning and maintenance. Another drawback is the relatively long valve shut time under reversing flow conditions.

Other single inlet check valves are based on sophisticated designs in which a ball is moveably disposed between a closed and an open position and guided by various guiding means. A flowing fluid flows around the ball in the open position under forward flow conditions but pushes the ball into a closed position against a valve seat to prevent reverse fluid flow. For example, such valves are disclosed in U.S. Pat. Nos. 6,899,127, 5,971,015, 5,794,656, 4,674,529, 4,286,622, 3,498,315 and 2,103,427. Improperly designed or dimensioned valve components can lead to certain critical fluid flow conditions with adverse effects, for example, cavitation and ball rattling.

A multiple inlet check valve can comprise one or more balls which can be moved by fluid inside a conduit of the check valve, wherein the conduit can join one or more inlets. The one or more balls can move either freely or be guided along guiding means. For example, U.S. Pat. Nos. 3,520,319, 3,509,900, 3,444,881 or Canadian Patent No. 852,992 disclose multiple inlet check valves, which are designed for particular large-scale applications such as in refineries or mines etc. Improperly dimensioned check valves may not be able to sustain conditions of prolonged high static and dynamic pressure. The considerable weight of large balls can expose the valve and attached piping to high shock forces under changing flow conditions. In addition, a system of check valves and pipes needs to be designed to be able to maintain sufficient structural integrity to sustain the inertia and absorb the kinetic energy which are of consideration during impacts of balls and when fluid in the system accelerates or decelerates. Many of the components of the disclosed large ball check valves may not be designed for a desired level of durability and safety.

Therefore, there is a need for a new ball check valve design that overcomes some of the drawbacks of known valves.

This background information is provided to reveal information believed by the applicant to be of possible relevance to the invention. No admission is necessarily intended, nor should be construed, that any of the preceding information constitutes prior art against the invention.

### SUMMARY OF THE INVENTION

An object of the invention is to provide a ball check valve. In accordance with an aspect of the invention, there is provided a ball check valve for enabling conveyance of a fluid through the ball check valve, the ball check valve comprising: a housing defining one or more inlets, an outlet and a passageway therebetween, a ball seat being defined at each of said one or more inlets; a ball support system positioned within the housing; and a ball reversibly moveable between two or more positions along the ball support system, a first of said positions being proximal to the ball seat defined at a given one of said one or more inlets wherein the ball mates with this ball seat to close said given inlet impeding fluid flow therethrough, a second of said positions being distant from the given inlet wherein fluid flow between the given inlet and the outlet is enabled; wherein the ball check valve is configured as a pressure vessel.

In accordance with another aspect of the invention, there is provided a ball check valve for enabling conveyance of a fluid through the ball check valve, the ball check valve comprising: a housing defining one or more inlets, an outlet and a passageway therebetween, a ball seat being defined at each of said one or more inlets; a ball support system positioned within the housing; and a ball reversibly moveable between two or more positions along the ball support system, a first of said positions being proximal to the ball seat defined at a given one of said one or more inlets wherein the ball mates with this ball seat to close said given inlet impeding fluid flow therethrough, a second of said positions being distant from the given inlet wherein fluid flow between the given inlet and the outlet is enabled; wherein a hardness of said ball is at least about 70% greater than that of each said ball seat.

### BRIEF DESCRIPTION OF THE FIGURES

FIG. 1A illustrates an end elevation view of a single inlet ball check valve according to one embodiment of the invention.

FIG. 1B illustrates a side cross sectional view of the single inlet ball check valve of FIG. 1A taken along line A-A thereof.

FIG. 2A illustrates an end elevation view of a centre section of the single inlet ball check valve of FIG. 1A.

FIG. 2B illustrates a side cross sectional view of the centre section of FIG. 2A taken along line A-A thereof.

FIG. 3A illustrates an end elevation view of an inlet section of the single inlet ball check valve of FIG. 1A.

FIG. 3B illustrates a side cross sectional view of the inlet section of FIG. 3A taken along line A-A thereof.

FIG. 4A illustrates an end elevation view of the outlet section of the single inlet ball check valve of FIG. 1A.

FIG. 4B illustrates a side cross sectional view of the outlet section of FIG. 4A taken along line A-A thereof.

FIG. 5 illustrates a cross sectional view of a single inlet ball check valve ball support element according to one embodiment of the invention.

FIG. 6 illustrates a cross sectional view of a ball for a single or multiple inlet ball check valve according to one embodiment of the invention.

FIG. 7A illustrates a top view of a two inlet ball check valve according to one embodiment of the invention.

FIG. 7B illustrates a side view of the two inlet ball check valve of FIG. 7A, showing a partial side cross section taken along line A-A thereof.

FIG. 7C illustrates a side cross sectional view of the two inlet ball check valve of FIG. 7B taken along line B-B thereof.

FIG. 8A illustrates a top view of a centre/outlet section of the two inlet ball check valve of FIG. 7A.

FIG. 8B illustrates a side view of the centre/outlet section of FIG. 8A, showing a partial side cross section taken along line A-A thereof.

FIG. 8C illustrates a side cross sectional view of the centre/outlet section of FIG. 8B taken along line B-B thereof.

FIG. 9A illustrates a bottom view of an inlet section of the two inlet ball check valve of FIG. 7A.

FIG. 9B illustrates a side view of the inlet section of FIG. 9A, showing a partial cross section taken along line A-A thereof.

FIG. 9C illustrates a cross sectional view of the inlet section of FIG. 9B taken along line B-B thereof.

FIG. 10A illustrates a top view of an inlet base element of the two inlet ball check valve of FIG. 7A.

FIG. 10B illustrates a cross sectional view of the inlet base element of FIG. 10A taken along line A-A thereof.

FIG. 11A illustrates an elevation view of an inlet side element of the two inlet ball check valve of FIG. 7A.

FIG. 11B illustrates a cross sectional view of the inlet side element of FIG. 11A.

FIG. 12A illustrates an end view of a centre/outlet section wall element of the two inlet ball check valve of FIG. 7A.

FIG. 12B illustrates a cross sectional view of the centre/outlet section wall element of FIG. 12A.

FIG. 13 illustrates a top view of a centre/outlet section side element of the two inlet ball check valve of FIG. 7A.

FIG. 14A illustrates a top view of a two inlet ball check valve according to another embodiment of the invention.

FIG. 14B illustrates a side view of the two inlet ball check valve of FIG. 14A, showing a partial side cross section taken along line A-A thereof.

FIG. 14C illustrates a side cross sectional view of the two inlet ball check valve of FIG. 14B taken along line B-B thereof.

FIG. 15A illustrates a top view of a centre/outlet section of the two inlet ball check valve of FIG. 14A.

FIG. 15B illustrates a side view of the centre/outlet section of FIG. 15A, showing a partial side cross section taken along line A-A thereof.

FIG. 15C illustrates a side cross sectional view of the centre/outlet section of FIG. 15B taken along line B-B thereof.

FIG. 16A illustrates a bottom view of an inlet section of the two inlet ball check valve of FIG. 14A.

FIG. 16B illustrates a side view of the inlet section of FIG. 16A, showing a partial cross section taken along line A-A thereof.

FIG. 16C illustrates a cross sectional view of the inlet section of FIG. 16B taken along line B-B thereof.

FIG. 17A illustrates an elevation view of an inlet side element of the two inlet ball check valve of FIG. 14A.

FIG. 17B illustrates a cross sectional view of the inlet side element of FIG. 17A.

### DETAILED DESCRIPTION OF THE INVENTION

Unless defined otherwise, all technical and scientific terms used herein have the same meaning as commonly understood by one of ordinary skill in the art to which this invention belongs.

The term “fluid” is defined to refer to any liquid or gaseous substance, which may in some embodiments comprise insoluble matter that may for example be suspended within the liquid or gaseous substance, and that can be conveyed as a flowing substance.

The term “shore” is defined to refer to a unit for comparing hardness, for example of a material or the like. For example, lower shore values generally represent softer materials whereas higher shore values generally represent harder materials.

As used herein, the term “about” refers to a +/−10% variation from the nominal value. It is to be understood that such a variation is always included in any given value provided herein, whether or not it is specifically referred to.

Ball check valves can be used in large-scale applications partly due to their relatively simple automated shut off capabilities. In particular, ball check valves can be suited for use in plant applications that require self-regulation and rugged design. Examples of such applications may include, but are not limited to, mining separation systems (e.g. to pump slurry—water and crushed ore solution), water treatment plants, pulp and paper mills, etc. In general, the valves described hereinbelow in accordance with various embodiments of the invention, may be used in interior or exterior fluid conveyance systems wherein the conveyed fluid may comprise various particles or solids to be conveyed therewith for downstream processing.

In general, large-scale ball check valves can significantly differ in design from small-scale implementations. During operation ball check valves are exposed to a number of forces, which can have different causes. The design of small ball check valves is typically determined by static operating pressure conditions, whereas large ball check valves are additionally prone to effects of moving masses, for example moving valve components and flowing fluid. Consequently, the design of large ball check valves can be significantly different from their small-scale counterparts. Important parameters for the design of ball check valves can include forward flow rate, shut time, physical and chemical properties of the to-be-conveyed fluid and desired valve life cycle. Life cycle considerations can greatly affect the viability of a ball check valve design and its safe implementation in a particular application. In addition, safety and environmental considerations can be equally important for life cycle considerations that can affect the ball check valve configuration. For instance, safety and environmental considerations when dealing with potentially harmful fluids may require that the likelihood of leaks be reduced or substantially eliminated between components of the valve or between the valve and associated inlet/outlet pipes. Providing appropriately designed valve components and coupling structures may thus be requested for certain applications to enhance an integrity of the valve and its connection to an associated pipe network.

The invention provides an uncomplicated ball check valve whose components can be economically manufactured, assembled and connected and wherein, in accordance with one aspect of the invention, the ball check valve is configured for use as a pressure vessel.

In one embodiment of the invention, the ball check valve comprises a housing defining one or more inlets, an outlet and a passageway therebetween. A ball support system is mounted within the housing, wherein one or more balls are supported by the ball support system. The ball support system is configured to allow a ball to close off and open a respective inlet.

The housing generally comprises an inlet section which can have one or more inlets, wherein each inlet defines a ball seat for engaging a ball which can close the inlet. The housing further comprises a centre section providing adequate space to allow movement of the ball and an outlet section comprising an outlet for transferring the fluid to a subsequent portion of a piping network. The ball support system is configured to guide the movement of each of the one or more balls, wherein the movement of each ball is guided from a closed position to an open position. In the closed position the ball is proximate to a respective ball seat of an inlet where it seals and closes off that inlet. In the open position, the ball provides a specified level of fluid flow from the inlet through the valve to the outlet.

In one embodiment of the invention, two or more sections of the housing can be integrally formed as a single unit or each of the sections can be individually fabricated and form separate parts to be assembled using conventional methods such as bolting, welding, riveting and the like.

The valve may also generally comprise an inlet coupling structure and an outlet coupling structure for each of the one or more inlets and the outlet of the housing for coupling same to upstream and downstream pipes of a piping network respectively. These coupling structures may comprise various types of flanged or mating structures integrally formed within the housing, or sections thereof, or secured thereto using conventional methods such as welding, bolting, or the like. It will be appreciated that components of the coupling structures may partake directly or indirectly in the formation of the ball seat defined respectively at each housing inlet, or may be coupled to the housing via intermediary components of the housing distancing these structures from direct contribution to the formation of such seats. Examples of coupling structures may include flat face flanges, raised face flanges, and the like, either directly coupled to the housing, or distanced therefrom via appropriate pipe sections or the like.

### Check Valve Housing

The housing of the ball check valve according to one embodiment of the invention comprises one or more inlets, an outlet and a passageway therebetween. The housing generally comprises an inlet section defining the one or more inlets, a centre section and an outlet section defining the outlet; together, these sections define the interior region of the ball check valve. Each of the one or more inlets defines a ball seat for engaging a ball which can close the inlet. The centre section is configured to provide adequate space to allow movement of the ball and fluid and the outlet section comprises an outlet for transferring the fluid to a subsequent portion of a piping network. The sections of the housing can be connected, for example, welded, riveted, bolted or screwed, or be integrally formed as a single unit. In one embodiment, screws or bolts can provide ease of access to the interior of the ball check valve for maintenance, part replacement or inspection, for example.

The valve may also generally comprise an inlet coupling structure and an outlet coupling structure for each of the one or more inlets and the outlet of the housing for coupling same to upstream and downstream pipes of a piping network respectively. These coupling structures may comprise various types of flanged or mating structures integrally formed within the housing, or sections thereof, or secured thereto using conventional methods such as welding, bolting, or the like. It will be appreciated that components of the coupling structures may partake directly or indirectly in the formation of the ball seat defined respectively at each housing inlet, or may be coupled to the housing via intermediary components of the housing distancing these structures from direct contribution to the formation of such seats. Examples of coupling structures may include flat face flanges, raised face flanges, and the like, either directly coupled to the housing, or distanced therefrom via appropriate pipe sections or the like.

The ball check valve housing embodiments of the invention are designed to control forces caused by large moving masses which can further be accelerating or decelerating. In addition, the ball check valve provides a desired level of forward fluid flow and the ability to suppress fluid backflow through the valve. The ball check valve is also designed to allow desired switching conditions between open and closed states.

Desired switching conditions can prevail when a specified minimal level of forces affect the valve components and/or any infrastructure attached to the valve as a consequence of the ball check valve opening or closing.

Large-scale ball check valve embodiments of the invention comprise large-scale balls typically of significant masses, which can accelerate, move and decelerate inside the valve between two extreme positions. Each acceleration or deceleration of the ball goes in line with a ball impact on either a ball seat or the ball support system and requires acceleration or deceleration both of the ball and of the fluid in the valve and in the attached piping network. The ball check valve can be capable of safely absorbing shock forces of moving fluid pushing the ball into the valve seat or pushing the ball onto the ball support system under changing valve operating conditions. The check valve is capable of withstanding temporary dynamic pressure conditions which can be in great excess of the ones that normally prevail during static operating conditions.

Check valves and other flow control apparatus embodiments of the invention can be classified according to the kind of fluid and the operating pressure for which they are designed. According to an aspect of the invention, the ball check valve is considered a pressure vessel, and therefore may be subject to certain regulative standards, which may vary across jurisdictions. The American Society of Mechanical Engineers (ASME) provides, among other services, guidelines and certifications for designs of welded pressure vessels, which are intended for operation under high pressure conditions. Other standards-defining bodies are ANSI, ISO, and DIN. Check valves need to meet predefined structural requirements to make their operation safe and secure. A number of techniques can be used for the manufacturing of ball check valves and their components. For example, the housing can be substantially integrally shaped and cast or the housing can be fabricated from components fastened together by welding or bolting, for example.

The housing embodiments of the invention can be manufactured from a number of different types of materials provided that the materials provide the ball check valve with required strength, weight and longevity. The housing can be manufactured from a suitable grade of material such as metal, for example. The material can be mild steel, hardened steel, heat treated steel or high-strength steel of a desired alloy composition, for example. Other metal alloys or composite materials may be used, provided that the corresponding structural strength, chemical resistance or other requirements are met. For example, in one embodiment, a material having a sufficiently high yield and/or tensile strength is used to meet structural requirements intended for a given application. For instance, to meet certain requirements in implementing the ball check valve as a pressure vessel, the valve housing may need to be manufactured of materials exhibiting sufficiently high mechanical and/or structural characteristic values. In one embodiment, boilerplate or higher grade steel is used to achieve these characteristics. In another embodiment, materials exhibiting yield strengths equal or greater than about 355 N/mm² and/or tensile strengths equal or greater than about 510 N/mm² are used.

In one embodiment of the invention, the housing and, if modularly designed, the housing sections such as the inlet section, centre section and the outlet section, can be manufactured from a plurality of pieces of material specifically shaped and fastened together to form the housing. For example, parts of a section can be fastened using welding or other methods that would be appropriate to the specific material in question. The fastening technology must meet the structural and strength requirements for the housing such as operating pressure, for example. To meet ASME standards, a weld seam, for example, must provide a specified level of weld penetration into the parent material and provide a specified type of weld material dependent upon the welding technology. Furthermore, weld seams can be tested using a suitable technique, for example x-ray scanning or any other suitable non-destructive evaluation technique, thereby ensuring an appropriate quality of weld seam in order to achieve the desired level of strength and durability for a ball check valve configured as a pressure vessel.

The sections of the housing of the ball check valve require a minimum intrinsic structural strength, and special welding techniques and welding seams are required to make the ball check valve rugged enabling its operation to be safe and secure. For example, the sections of the housing can be welded according to ASME with SFA 5.18 class E70C-6M-H4 or FCAW E4801T-9-CH electrodes. The sections can be constructed such that the housing of the ball check valve can be assembled in such a way that substantially a maximum amount of welding can be performed while causing a minimum amount of distortion to the sections. The edges of the valve sections can be chamfered where required, in order to enhance the weld penetration for example. In addition, the size of the sections for fabricating the housing substantially size approximately linearly with size of the ball placed within the housing.

In another embodiment, the housing of the ball check valve is equipped with optional elements which further increase the structural integrity of the housing. For example, these optional elements can be support struts, cover plates, framing elements or other elements, which provide a desired level of increased structural integrity to the housing.

In yet another embodiment the connection between the multiple sections of the housing, if formed as separate parts is provided by rivets, bolts or screws or any other suitable fastening devices, which are configured to join mating flanges of adjacent sections of the housing. For example, mating flanges may be integrally formed within various portions of the housing, or secured thereto (e.g. welded or otherwise coupled thereto) and adapted to join adjacent sections of the housing. These fastening devices can be fabricated from a variety of materials, which may be the same or differ from those used to fabricate the housing (e.g. housing walls, structural elements, etc.), provided that the desired connection can be made using these materials. Yet another example involves that the bolted connection be designed as a slip connection or a bearing connection, wherein depending on the type of connection the bolts are specifically designed for a particular type of function. The number of required fastening devices, for example bolts or screws can be selected to meet or exceed ASME standards. Furthermore, the bolts or screws can be adequately torqued using standard procedures as would be known to a worker skilled in the art, in order to achieve the desired type of connection between the sections of the housing and to provide a desired quality even seal between the sections. In addition, the bolts can be fabricated from mild steel, high-strength steel or other materials provided that the desired connection level and bolt dimensions can be achieved using the bolt material type.

Fastening devices, for example bolts, screws or rivets, in conjunction with connection flanges on the inlet and outlet coupling structures of the ball check valve which are proximate to the inlet(s) and outlet(s) respectively may be configured for mating and sealing with a piping network, thereby providing for fluid flow into and out of the ball check valve. In one embodiment of the invention, the pattern of the fastening devices associated with a connection flange can be selected to be compatible with known patterns in the art thereby providing ease of mating of the ball check valve with a piping network, for example.

As would be known to a worker skilled in the art, the shape, thickness and configuration of the flanges associated with the housing and/or coupling structures, can be modified provided that the desired functionality of the ball check valve can be obtained, for example enabling the ball check valve to operate under the conditions of a pressure vessel. Furthermore the pattern of fastening devices can further be varied, however considerations of fastening device patterns used for pipe networks in a given industry may limit the extent of adjustment of these fastening device patterns.

In another embodiment, wherein the multiple sections of the housing are connected using fastening devices, each of the connections and seals effected by the fastening devices can further comprise a sealing means, for example a gasket or sealing ring that can provide for further sealing of the connection. For example, through the use of a sealing means, the required tolerance of the mating portions of a section may be relieved as the sealing means may be capable of deformation in order to compensate for loosened tolerances. The sealing means can be specifically designed in order to enable the ball check valve to operate at a desired pressure level.

In yet another embodiment of the invention the ball check valve is built to safely operate under internal pressure conditions of about 4 MPa (about 40 bar) or more above ambient pressure. Consequently, the elements of the housing of the ball check valve which are exposed to this pressure difference must be designed to operate under these pressure conditions.

In a further embodiment of the invention, the housing of the ball check valve is constructed of ASTM (American Society for Testing Materials) or ASME (American Society of Mechanical Engineers) 516 grade 70 steel (i.e. A 516-70, SA 516-70, etc.), 44W steel or stainless steel grades 304 or 316, for example.

In another embodiment of the invention, a liner is disposed on the inside surface of the ball check valve housing. The liner provides a means for the reduction of abrasion of the housing due to the movement of the fluid. For example, cavitation, suspended solids and slurry fluids may cause pitting if the inside surface of the housing is unprotected. The design of the liner can be directly related to the type of material from which the housing is manufactured. For example a housing manufactured from mild steel may be more prone to pitting compared to one made of high-strength steel.

In yet another embodiment of the invention, the liner is disposed proximate to or mounted onto the inside surface of the housing at predetermined locations. Locations for sections of lined surface can be determined based on the fluid impact points during fluid movement in a fully open configuration in addition to transitional configurations from the fully open configuration to a fully closed configuration. By evaluating the impact locations of the fluid, the desired positions of the liner can be determined.

In an alternate embodiment of the invention, the entire inside surface of the housing of the ball check valve is coated with a liner. In yet another embodiment, a liner is further provided to cover the inside surface of the housing and inlet/outlet coupling structures provided therewith.

In an embodiment of the invention, the liner can be designed from a material that can be sprayed on the interior of the housing and subsequently solidified or vulcanized for example, in order to provide the desired level of protection. Alternately, the liner can be glued or adhered by other means to the inside surface of the check valve.

In one embodiment, the liner integrally extends beyond the inside surface of the ball check valve and covers any inlet and outlet and the respective flange surfaces (e.g. coupling flanges of valve sections, inlet/outlet coupling structures, etc.) thereby providing a seal gasket, for example.

In another embodiment, the disposed liner material can be vulcanized in a steam oven. For example, vulcanized material can provide an integrally shaped seamless liner which can extend from the inlet through the interior of the valve to the outlet. Vulcanized rubber can protect the inside surface of the valve from impacting objects and particles.

In one embodiment, the liner positioned within the housing of the ball check valve can be manufactured from one or more of a plurality of materials, wherein these materials provide the desired level of protection while minimizing the impact of the flow of fluid through the ball check valve. For example the liner can be manufactured from a rubber, vulcanized rubber, steel reinforced vulcanized rubber, a polymer or any other suitable type of material that can be applied or shaped to coat the inside surface of the housing and can provide the desired level of abrasion resistance and impact protection.

In yet another embodiment of the invention, the selection of the liner material can be dependent on the type of fluid which will be passing through the ball check valve. For example, different fluids such as oils, slurries, etc. may require or benefit from using different liners that may include, but are not limited to, nitrile rubber, pure gum rubber, neoprene, EPDM (Ethylene-Propylene-Diene-Monomer) and urethane liner materials. For instance, pure gum rubber liners are generally tough, impact and abrasion resistant; nitriles generally provide good oil and fuel resistance; urethane generally provides good impact and oil resistance; and EPDM (Ethylene-Propylene-Diene-Monomer) generally provides greater thermal and chemical resistance. Other materials, possibly selected as a function of the application for which the valve is to be used, should be apparent to the person skilled in the art and therefore, are not considered to depart from the general scope and nature of the present disclosure.

In one embodiment of the invention, the lining of the ball check valve housing has a hardness of between about 10 shore and about 50 shore for a desired level of ball seating and sealing with the ball seat associated with an inlet. In another embodiment, the lining of the ball check valve housing has a hardness of between about 10 shore and 30 shore which can improve the seal of a ball seat with the ball in a closed position. In a further embodiment, the lining of the ball check valve housing has a hardness of about 20 shore.

In one embodiment, a liner is disposed within the housing to cover the respective ball seat of each of the one or more inlets defined in the housing. In one embodiment, the hardness of the ball used in the ball check valve is at least about 70% greater than that of the covered ball seats. In another embodiment, the hardness of the ball is at least about 100% greater than that of the covered ball seats. hi general, proper selection of the hardness ratio between the ball and the ball seats allows for the harder ball to adequately sit within a given softer seat. However, when the ratio is too high, damage to the ball seat liner may ensue, or again, the ball may experience greater chances of getting stuck or wedged in a given seat. As will be discussed below, proper selection of a ball cover, when applicable, may be necessary to achieve an adequate ball-to-seat hardness ratio.

In general, when a liner becomes worn it can be replaced in part or in its entirety, for example the ball check valve can be relined. In one embodiment of the invention, the thickness of the liner can be varied depending on its position within the housing. For example, regions of the liner which exhibit a higher degree of wear can be configured to be thicker thereby providing a desired longevity to the ball check valve, for example.

In an embodiment of the invention, the exterior of the ball check valve is coated or painted to suppress corrosion. For example the ball check valve can be coated with any desired paint, coat or emulsion, for example, 316 stainless steel flake pigment.

### Ball and Ball Support System

In conjunction with the housing, the ball check valve further comprises one or more balls and a ball support system, wherein the one or more balls and the ball support system provide desired structural support and desired fluid flow dynamic properties. The ball support system provides a means to guide and entrain the ball during valve switching conditions and can support the ball in either or both an open position or a closed position. The ball support system can be configured to be minimally invasive on the fluid flow in forward direction, when fluid flow through the ball check valve is desired or to enhance the impact of fluid on the ball under reversing fluid flow conditions to better impede fluid flow and provide faster valve shut times, for example. The impact of the fluid upon a ball can drag the ball such that it can be moved out of an open position and into a closed position proximal to the ball seat for the respective inlet in the inlet section of the housing.

In an embodiment, the one or more balls and the ball support system are designed and dimensioned to mitigate the consequences of ball impact on the ball seat and additionally can be designed in conjunction with the housing to help reduce shock forces which can result from a ball impact and sudden stop of the conveyed fluid.

In another embodiment, the ball support system provides a means for decelerating the movement of the one or more balls during the final phase of position transients, for example when the ball approaches the ball seat and/or when the ball moves towards a fully open position.

In yet another embodiment, the ball support system is designed to absorb the momentum of the moving ball at a point before the ball reaches a fully closed position, or, alternatively a fully open position. For example localized fluid flow conditions or friction effects may support decelerating the ball before it reaches the fully open or fully closed position. The ball speed can be reduced, for example gradually in order to reduce the momentum of the ball, thereby reducing impact or diminishing the level of impact the ball will have upon reaching a stationary position, for example proximate to a ball seat resulting in inlet closure, or reaching a ball position allowing fluid movement through the ball check valve.

In yet a further embodiment of the invention, the ball support system comprises a liner mounted thereon which can provide impact resistance during ball movement and provide a means for protection of the ball support system from abrasion due to fluid movement. The liner can be manufactured from a rubber, vulcanized rubber, steel reinforced vulcanized rubber, a polymer or any other type of material that may be shaped to coat the ball support system and can provide the desired level of abrasion resistance and impact protection. The selection of the liner can further be dependent on the mass and size of the one or more balls to be supported thereon. For example, a denser ball will impart a greater level of compression on the liner, and therefore this can be accounted for by using a material with a desired stiffness, as a liner material with a lower stiffness than the desired level may impede movement of the ball due to compression of the liner.

In a further embodiment, the liner is formed from a compressive material which can provide a means for reducing the momentum of the ball during for example final stages of ball movement transients.

In one embodiment a compressive liner can work in conjunction with the ball support system for reducing ball momentum during the final stages of ball movement to a stationary position, in an open or closed position. The liner associated with the ball support system can be manufactured from a plurality of materials, wherein these materials provide the desired level of protection and/or compression.

Each of the one or more balls of the ball check valve can be manufactured from one or more materials. For example a ball can be manufactured from one or more of plastic or rubber, metal, metal foams or composite materials, or any other suitable material which can be determined based on material characteristics including for example, abrasion resistance, strength, density and impact resistance. To prevent excessive abrasion due to ball chatter or vibrations the ball can be made of a number of materials of different specific weight.

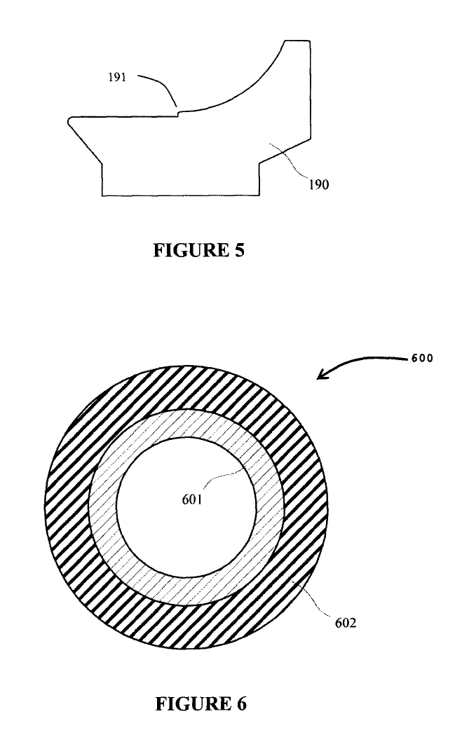

FIG. 6 illustrates an example of a ball according to one embodiment of the invention. The ball comprises a hollow aluminium spherical hull 601 which is disposed in a spherical shell of rubber 602. The dimensions of the ball components as well as the components' material composition can be chosen for improved ball buoyancy while maintaining required structural integrity. The ball can have a non-spherical outer surface, for example an ellipsoid, to improve valve shut times and fluid dynamics. It is understood that the ball can be solid or hollow.

In an embodiment of the invention, the ball diameter is between about 10% and 50% greater than its respective inlet and in another embodiment the ball diameter is between about 20% and 40% greater than its respective inlet.

In one embodiment of the invention, the one or more balls are coated with a cover material, for example vulcanized rubber or other suitable material, wherein this cover material has a hardness of about 40 shore or higher.

In another embodiment of the invention, the cover material has a hardness of about 60 shore or higher. In a further embodiment, the covering material is selected such that a hardness of the ball is at least about 70% greater than that of the housing liner (e.g. the liner covering the valve's one or more ball seats, one or more support elements, etc.).

In yet another embodiment, the covering material is selected such that a hardness of the ball is at least about 100% greater than that of the housing liner. As discussed above, proper selection of the hardness ratio between the ball and the ball seats allows for the harder ball to adequately sit within a given softer seat. However, when the ratio is too high, damage to the ball seat liner may ensue, or again, the ball may experience greater chances of getting stuck or wedged in a given seat.

The ball support system defines a region for movement of the one or more balls within the ball check valve. The cross section of the movement region defined by the ball support system, namely the spatial area defined by the ball support elements of the ball support system, can be created to provide a desired level of guidance on the movement of the ball while limiting impediments to the movement of the ball along the ball support system. This clearance distance between the cross section of the movement region relative to the ball diameter can be determined based on the type of fluid being transferred through the ball check valve. For example, if water is being transferred the relative clearance can be less than that for a fluid comprising a plurality of suspended solids for example a slurry. The clearance can be determined based on the intended use of the ball check valve as would be known to a worker skilled in the art. For example in one embodiment of the invention, the ball check valve is configured to have a ball clearance of about 1/10 to about 1/30 of the ball diameter. In an alternate embodiment, the ball clearance is about 1/20 of the ball diameter.

### Single Inlet Ball Check Valve

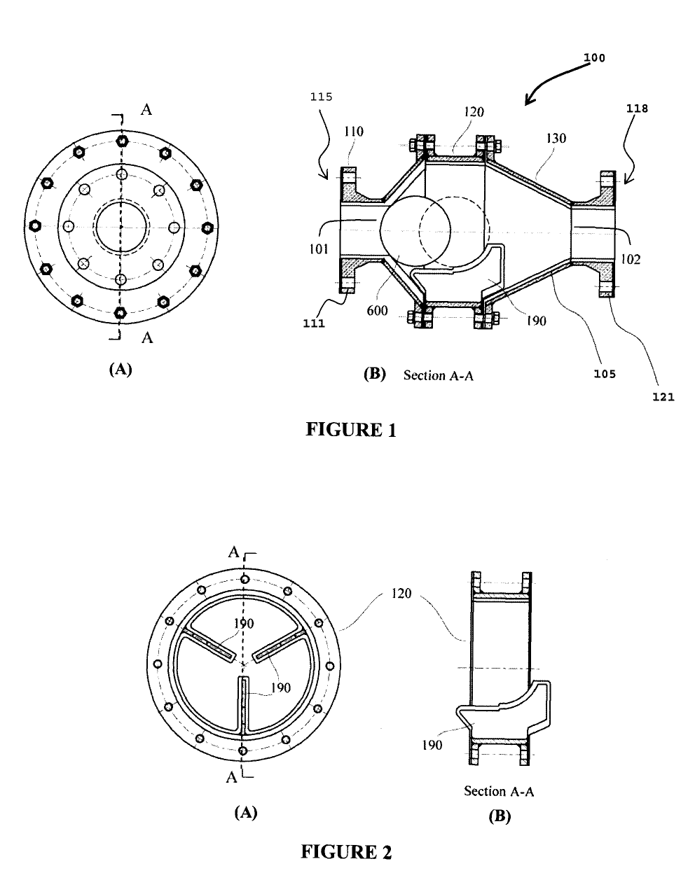

Referring now to FIGS. 1A and 1B, a single inlet ball check valve, generally referred to using the numeral 100 and in accordance with an embodiment of the invention, is illustrated in an end elevation view and a side cross sectional view respectively. The valve 100 generally comprises a housing 105 defining an inlet 101, an outlet 102 and a passageway therebetween. The valve further comprises an inlet coupling structure 115 integrally coupled to the inlet 101, the inlet coupling structure illustratively comprising a coupling flange 111 for coupling the inlet 101 to a respective inlet pipe or the like (not shown) using a number of appropriately selected bolts, rivets or the like. The valve also further comprises an outlet coupling structure 118 integrally coupled to the outlet 102, illustratively comprising a flange 121 for coupling the outlet 102 to an outlet pipe or the like (also not shown) using a number of appropriately selected bolts, rivets or the like. In this embodiment, the flanges 111 and 121 are illustrated as flat face flanges, however, these flanges may also be configured to have a raised face and/or have a desired degree flatness in order to achieve a selected seal between the respective flange and an adjacent pipe of a network, for example.

In this embodiment, the valve 100 comprises an inlet section 110 (e.g. comprising an inlet section of the housing 105 and the inlet coupling structure 115), an outlet section 130 (e.g. comprising an outlet section of the housing 105 and the outlet coupling structure 118) with a centre section 120 positioned therebetween.

The ball check valve further comprises a ball 600 and a ball support system, the latter illustratively comprising three or more ball support elements 190 which are concentrically disposed about a transverse axis of the housing 105. Only one ball support element 190 is illustrated in the cross sectional view of FIG. 1.

Protective liners are disposed on the inside surfaces of the housing 105 (and coupling structures 115, 118) in order to protect these surfaces from abrasion due to adverse flow conditions, chemical environments or particle impact. Each of the inlet section 110, the centre section 120, and the outlet section 130 has its own liner, which extends across the inside of the housing 105, across the flange surfaces adjoining these sections, and across the coupling surfaces of the flanges 111 and 121. The liner can be made of an abrasion resistive material, for example, synthetic rubber, or any other suitable material well known to a person skilled in this art.

The conduit between the inlet 101 and the outlet 102 can be closed by the ball 600 to interrupt fluid flow. The valve 100 can be closed by centrically aligning the ball 600 with the inlet section 110 and pressing it against an annular portion of the liner of the inlet section which forms a ball seat. The ball 600 can be biased, for example by gravity, or it can be pressed against the liner of the inlet section 110 when pressure at the outlet 102 of the ball check valve exceeds pressure at the inlet 101 of the ball check valve 100.

The ball support elements 190 can entrain the ball and limit its movement along a transverse axis of the housing 105. The liner and the ball support system define a ball slackness of tubular volume by confining the motion of the ball 600 and prohibiting the ball 600 from moving beyond a fixed distance from the ball seat. The ball slackness in combination with the inside dimensions of the lined housing 105 and the intended use with fluids of certain compositions and flow conditions are important considerations when determining ball check valve shut times under reversing flow conditions.

An example ball support element 190 according to one embodiment of the invention is illustrated in an elevated view in FIG. 5. The illustrated ball support element 190 generally comprises a substantially horizontal portion proximal to the ball seat for supporting the ball 600 when in a substantially closed position (the substantially closed position is illustrated with solid lines in FIG. 1B), an upwardly arcuate portion defining a ball stop for restricting travel of the ball 600 away from this substantially closed position (this position is illustrated with phantom lines in FIG. 1B), and a step portion 191 therebetween for urging the ball 600 toward the substantially closed position, for example. In general, this step 191 may help narrow the ball movement tolerance and conically center the ball 600 when the ball moves proximate to or in the fully open position (phantom lines). Step 191 can also provide a means for decreasing the momentum of the ball upon reaching close proximity of the fully open position. Furthermore step 191 provides a means for improved acceleration of the ball during open to close transients. As illustrated in FIG. 1B, the ball moves conically centered proximate to the ball seat for desired closure of the inlet 101.

It will be understood that step sizes and shapes other than that illustrated in FIG. 5 may be contemplated herein to provide similar results, as can other softer and/or curved surface variations. Such variations are not considered to depart from the general scope and nature of the present disclosure.

In general, each ball support element 190 is disposed within and protected by a liner. It is understood that the liner for the ball support elements 190 and the liner for the centre section 120 can be integrally shaped bodies. The ball support system and its elements can be scaled to different sizes within a wide range without requiring a change in design.

In one embodiment of the invention, and with further reference to FIG. 5, step 191 is further configured to provide a means for placement of additional liner material onto the ball support element 190. The region of the ball support element 190 which is positioned proximate to the inlet 101 of the ball check valve 100 and which is prior to the step 191 (i.e. the substantially horizontal portion described above), can be a heavily impacted region of the ball support element 190. Therefore, by providing additional liner in this region, potential damage to this region of the ball support element 190 can be reduced. The step 191 may provide a means for a relatively even surface being exposed to the ball 600 by the ball support system, wherein additional protection is provided in a region of greater potential damage, namely the region proximate to the inlet 101 of the ball check valve 100.

As introduced above, the inlet section 110 comprises an attachment element or coupling structure 115, for example, an inlet flange 111 for connection of the inlet section 110 to a pipe of the pipe network, for example. The opposite end of the inlet section 110 comprises a second attachment element, for example, a mating flange for connection of the inlet section 110 to the adjacent centre section 120 of the valve 100. The outlet section 130 is similarly configured, wherein the outlet section 130 comprises an attachment element or coupling structure 118, for example, an outlet flange 121 for connection of the outlet section 130 to a pipe of the pipe network, for example. The opposite end of the outlet section 130 comprises a second attachment element, for example, a mating flange for connection of the outlet section 130 to the adjacent centre section 120 of the valve 100. The inlet section 110, outlet section 130 and centre section 120 define a conduit or passageway therebetween which narrows when approaching either the inlet 101 or the outlet 102 of the ball check valve 100. As described above, various types of flanges may be considered depending on their intended purpose, the seal level required and the operating pressures contemplated. For instance, flat or raised face flanges, split flanges, and other such flanges may be used, for example.

The connection between the multiple sections of the valve 100, namely the inlet section 110, centre section 120 and the outlet section 130 can be provided by bolts, screws, welding or other suitable connection means as would be known to a worker skilled in the art. The means of connection between the sections can be selected based on accessibility to the interior of the housing 105, cost, structural integrity of the housing 105 or other factors.

In one embodiment of the invention, the inlet section 110 and outlet section 130 have the same shape, and can be connected to the centre section 120 as mirror images of each other. In an alternate embodiment, the inlet section 110 and the outlet section 130 are configured as different shapes.

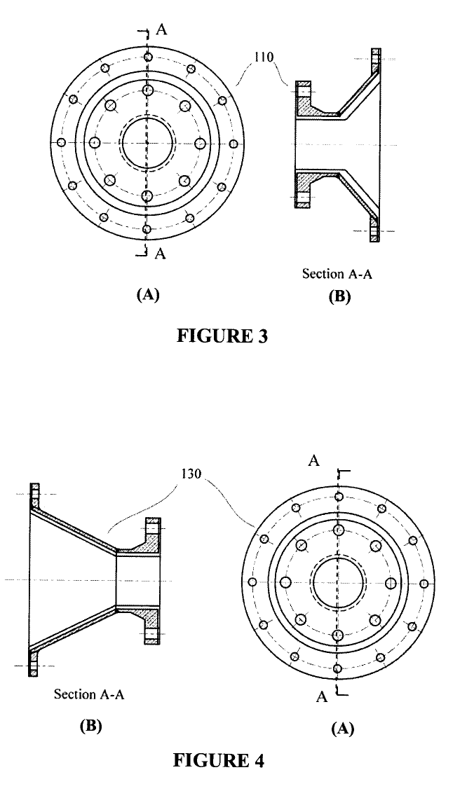

The centre section 120 comprises a substantially tubular member having an attachment means. This can be a flange as illustrated in FIGS. 2A and 2B at either end of the tubular member. As illustrated in FIGS. 2A, 2B, 3A, 3B, 4A and 4B each attachment means of the centre section 120, inlet section 110 or outlet section 130 can be mechanically secured by screws, bolts, interlocking mechanisms or any other means or methods well known to someone skilled in this art. The attachment means can also be used to mechanically secure extending or protruding ends of impact resistant liners.

The inlet section 110, centre section 120 and outlet section 130 can be connected together in such a manner as to enable operation of the ball check valve 100 when a selected internal pressure is generated within the housing. For example, this connection can be selected to meet or exceed ASME standards with an adequate number of bolts or screws, for example. Bolts or screws can be torqued using standard procedures well known to a worker skilled in the art, in order that a predetermined seal and bearing pressure is created between the mating flanges respectively of the inlet section 110, the centre section 120 and the outlet section 130 of the ball check valve 100, thereby creating a selected high-quality even seal. For example, in one embodiment, grade 8 bolts are used to provide a greater seal and coupling strength at the juncture of these mating flanges.

Furthermore, in another embodiment, the housing 105 can be manufactured of a material having mechanical characteristics meeting or exceeding standards established for pressure vessels. For example, the various components of the housing 105, and optionally of the ball support elements 190, may be manufactured of a material having a yield strength at least greater or equal to about 355 N/mm², or a tensile strength at least greater or equal to about 510 N/mm², such as boilerplate steel (e.g. SA 516-70) or the like. In another example, these components may be manufactured of a material having a yield strength at least greater or equal to about 375 N/mm², or a tensile strength greater or equal to about 540 N/mm². It will understood by the person skilled in the art that the above figures may vary with temperature and as such, it will be appreciated that the above figures relate to general mechanical characteristics of the materials used in the disclosed embodiment when the valve 100 is operated at standard operation temperatures. A valve 100 designed for operation at high temperatures may thus require that a material be used which exhibits sufficiently high yield and/or tensile strengths at such high temperatures. These and other such embodiments are not considered to depart from the general scope and nature of the present disclosure.

In yet a further embodiment of the invention, the housing 105 of valve 100 is manufactured of a material having a yield strength greater or equal to about 355 N/mm², or greater or equal to about 375 N/mm². In another embodiment, the housing 105 of the valve 100 is manufactured of a material having a tensile strength greater or equal to about 510 N/mm², or greater or equal to about 540 N/mm². For example, the housing wall elements of the inlet, outlet and centre sections may be manufactured of boilerplate steel (e.g. SA 516-70) or the like. Other components of the valve 100 may be manufactured, for example, of the same or various other materials having mechanical characteristics of sufficient strength and quality to meet the operational requirements of the valve 100. For example, in one embodiment, the valve 100 is configured to operate as a pressure vessel and therefore, is constructed to comply with pressure vessel codes and regulations. For example, the valve 100, as described above, may be designed to meet the requirements of ASME BPV Code VIII-1. It will be apparent to the person skilled in the art that the valve 100, as described above, may also meet the requirements of similar codes and standards as defined by different institutions world-wide regulating the fabrication of pressure vessels to be used under conditions contemplated for the above-described valves.

In one embodiment, each section of the valve 100 has or holds a liner therein. In one embodiment of the invention, the liners may be flanged on the ends of each of the sections of the valve 100, namely the inlet section 110, centre section 120 and outlet section 130, to abut and seal against adjacent or connecting piping. In one embodiment, each of the liners may have an annular enlargement on the circumferential ends which can fit into a corresponding groove in each of the sections of the valve 100 which can provide a means for stabilizing or affixing the liners in position.

In an embodiment of the invention, in order to prevent ball chatter and vibration the ball 600 is entrained into the fluid by the ball support system which can also provide for laminar and smooth fluid flow with substantially a minimum level, if any, of turbulence as well as substantially maximum flow through in the open configuration of the ball check valve 100.

In another embodiment of the invention, the shape and size of the ball support element 190, the conduit defined within the inside the housing 105 and the size of the ball 600 are dimensioned to avoid flow turbulences inside the ball check valve 100 in forward fluid flow direction. The design of the ball support system can provide a means for substantially minimizing the cross sectional disturbance of the fluid flow which can permit maximum flow rate through the ball check valve 100 in the open configuration and can also expose the ball 600 to substantially a maximum fluid impact under reverse pressure conditions which can provide a means for moving the ball 600 more rapidly towards the ball seat and can lead to substantially a desired minimal transient ball check valve shut time.

In a further embodiment, the ball check valve 100 requires pressure differences equivalent to or higher than about twice the ball weight in order to move the ball out of the closed position in a desired transient time or to push the ball into and keep it in the closed position.

The ball check valve 100 according to one aspect of the invention can reduce shock forces in large-scale implementations which can be caused by certain kinetic conditions, for example impacts between the ball 600 and the ball seat, the ball 600 and the ball support system. The ball check valve 100 can further substantially absorb the kinetic energy and momentum of decelerating and accelerating fluid during valve shut and opening transients, respectively.

In one embodiment of the invention, the shape of the inside of the inlet section 110, the centre section 120, and the outlet section 130 of the valve 100 are dimensioned to reduce shear forces that can repetitively stretch the liners or detach the liners because of excessive dynamic pressure gradients or cavitation, for example. A ball check valve design according to the invention can extend the durability of the liner and can reduce the likelihood that the liner detaches or collapses under localized depression conditions inside the ball check valve.

### Multiple Inlet Ball Check Valve

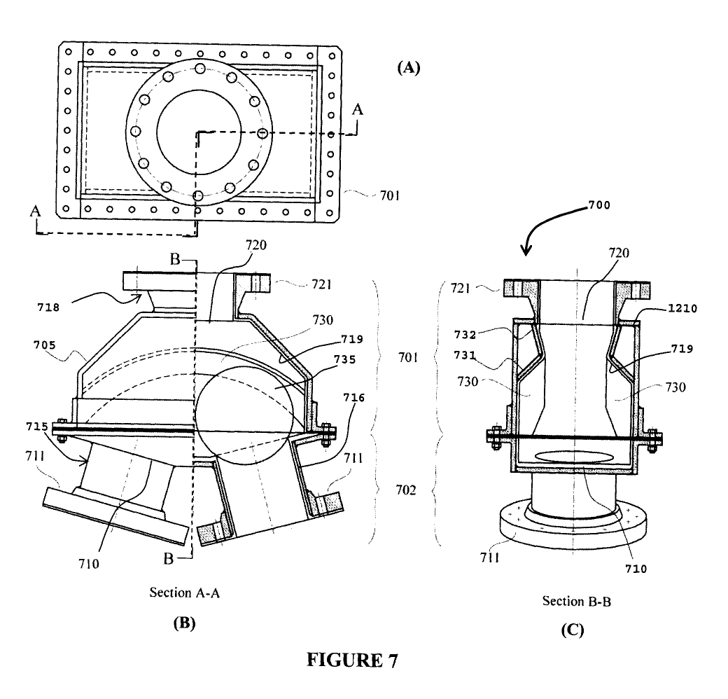

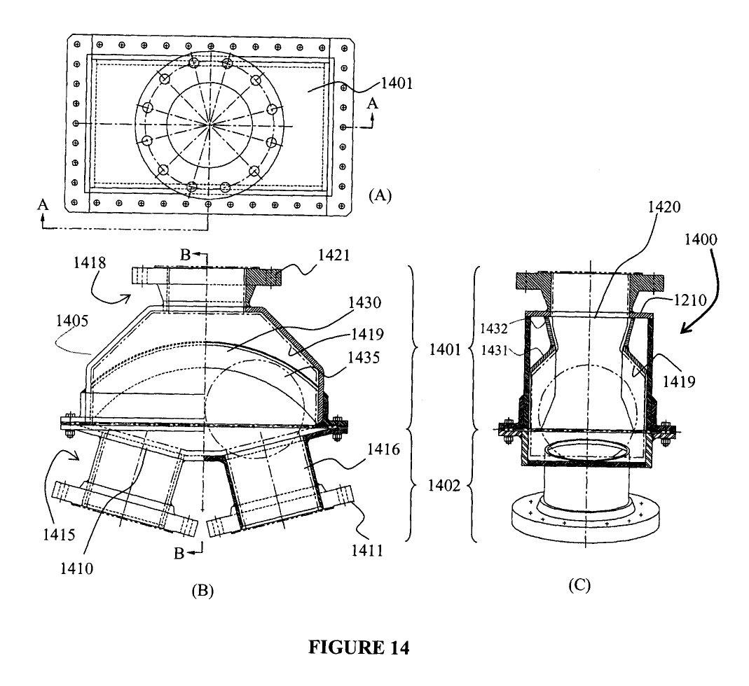

Referring now to FIGS. 7A, 7B and 7C a two inlet ball check valve, generally referred to using the numeral 700 and in accordance with an embodiment of the invention, is illustrated in a top view, a sectional view, and a cross sectional view respectively. The valve 700 comprises a housing 705 defining two inlets 710, an outlet 720 and a passageway therebetween. The valve 700 further comprises an inlet coupling structure 715 integrally coupled to each of the inlets 710, each of the inlet coupling structures 715 illustratively comprising a substantially cylindrical section 716 and a coupling flange 711 for coupling the inlet 710 to a respective inlet pipe or the like (not shown) using a number of appropriately selected bolts, rivets or the like. The valve also further comprises an outlet coupling structure 718 integrally coupled to the outlet 720, illustratively comprising a flange 721 for coupling the outlet 720 to an outlet pipe or the like (also not shown) using a number of appropriately selected bolts, rivets or the like. In this embodiment, the flanges 711 and 721 are illustrated as flat face flanges, however, as will be described below with reference to FIGS. 14 to 17, these flanges may be configured to have a raised face and/or to have a desired degree flatness in order to achieve a selected seal between the respective flange and an adjacent pipe of a network, for example.

In general, the inner surfaces of the housing, the inlet structures 715 and the outlet structure 718 are disposed with liners 719, the edges of which extending between mating sections of the valve 700 to provide an enhanced seal therebetween. The liners 719 may further extend along the annular mating surface of the flanges 711 and 721 to enhance a seal between these flanges and the respective flanges of an adjacent pipe, for example.

A ball 735 positioned inside the housing is generally guided by a guiding means, for example by guide rails 730, which form a portion of the ball support system which can entrain the ball subject to fluid flow and guide the movement of the ball 735 during operation of the ball check valve 700. The guide rails 730 extend all across the width of the interior of the ball check valve 700 and span proximate to the inside surface near the outlet 720 to support a laminar flow and suppress the formation of sediment deposits under operation. A liner 719 may also be disposed on the guide rails 730.

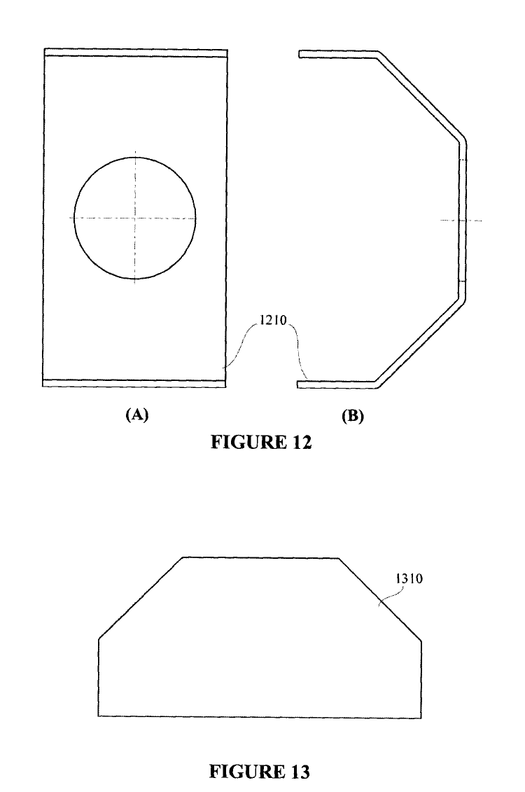

In the embodiment depicted in FIGS. 7 to 13, the valve's ball support system comprises a pair of guide rails 730 which run substantially parallel to each other across the width of the interior of the valve 700. The pair of guide rails 730 are generally defined by a pair of arcuate guides 731 inwardly projecting from the housing's side elements 1310 (e.g. see FIG. 13) to define an arcuate path therebetween linking the inlets 710 and reversibly guiding the ball thereon. In one example, the arcuate guides 731 form an angle of between about 30 and about 60 degrees with the side elements 1310, or of between about 40 degrees and about 50 degrees, or of about 45 degrees as illustrated herein, though other angles may be considered without departing from the general scope and nature of the present disclosure. A corresponding pair of rail support structures 732 are also provided coupling the arcuate guides 731 to a structural portion of the housing 705 angled relative to a plane of the arcuate path defined by the rails 730 (i.e. the path followed by the ball), thereby providing radial structural support thereto (note: in this embodiment, each rail support structure 732 and arcuate guide 731 combination block fluid flow from the space between them and the housing 705). In this embodiment, this structural portion of the housing comprises the wall element 1210 (e.g. see FIG. 12) which forms a right angle with this plane thereby providing increased radial support to the guide rails 730 as the ball 735 applies a pressure thereto. Furthermore, as seen in FIG. 7C, the rail support structures 732 of the present embodiment extend divergently toward and are coupled proximal to the outlet 720 reducing turbulence and sediment build up thereat. The location of the coupling of the rail support structure 732 to the wall element 1210 being proximal to the outlet 720 allows for smooth fluid flow through the outlet, decreasing or eliminating pooling or turbulent mixing of fluid in a pocket or region at the side wall elements 1210.

The person skilled in the art will understand that, although the present embodiment illustratively comprises rail support structures 732 leading to a structural portion of the housing 705 substantially perpendicular to the path defined by the guide rails 730, similar housing and support structure designs may also be contemplated wherein such a portion is angled relative to this path. For instance, a housing wall element disposed at an angle of at least about 30 degrees relative to the arcuate path could provide adequate support for the guide rails 730, albeit likely somewhat reduced as compared to the perpendicular design illustrated herein. Other angular designs could include, but are not limited to, housing wall elements disposed at an angle of about 45 degrees, 60 degrees, 75 degrees, etc. to provide increasing levels of support. Alternatively, designs coupling rail supports, as in supports 732, to the side element 1310, namely an element substantially parallel to the guide rail path, may also be contemplated herein without departing from the general scope and nature of the present disclosure, however, it will be appreciated that such designs may not provide as effective support to the guiderails 730 nor reduce turbulence and sediment build up as effectively as the rail support design depicted herein, or similar angled or perpendicular designs described above.

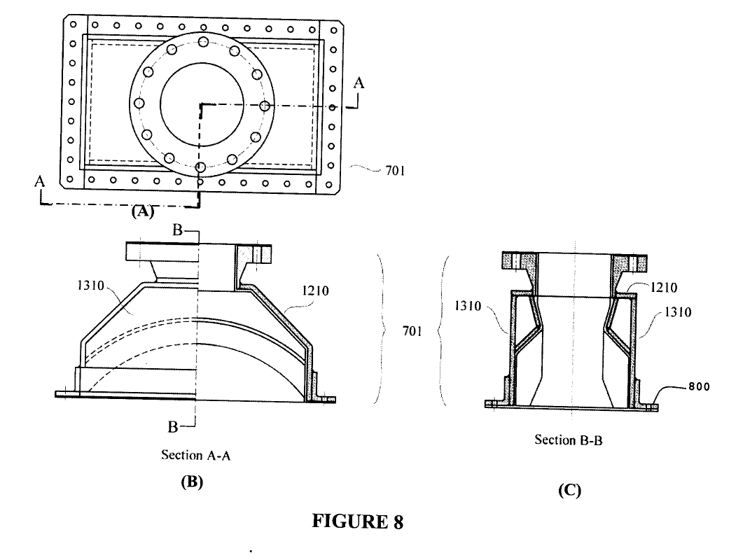

FIGS. 8A, 8B and 8C illustrate a top, a sectional, and a cross sectional view of centre/outlet section 701 of the two inlet ball check valve illustrated in FIG. 7A. Centre/outlet section 701 comprises a number of components which are formed, assembled and welded together, for example a wall element 1210 as illustrated separately in FIGS. 12A and 12B and a side element 1310 as illustrated separately in FIG. 13. The centre/outlet section 701 comprises a mating flange 800 which provides a means for connection of this section to the inlet section 702, thereby forming the housing 705 of the ball check valve 700.

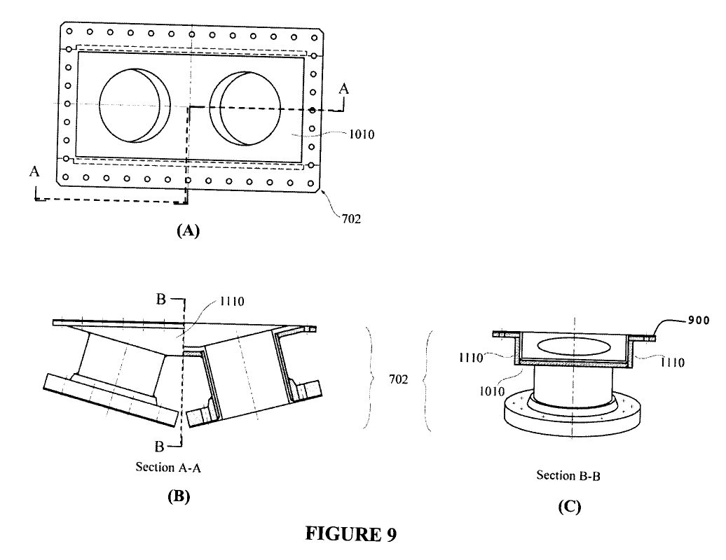

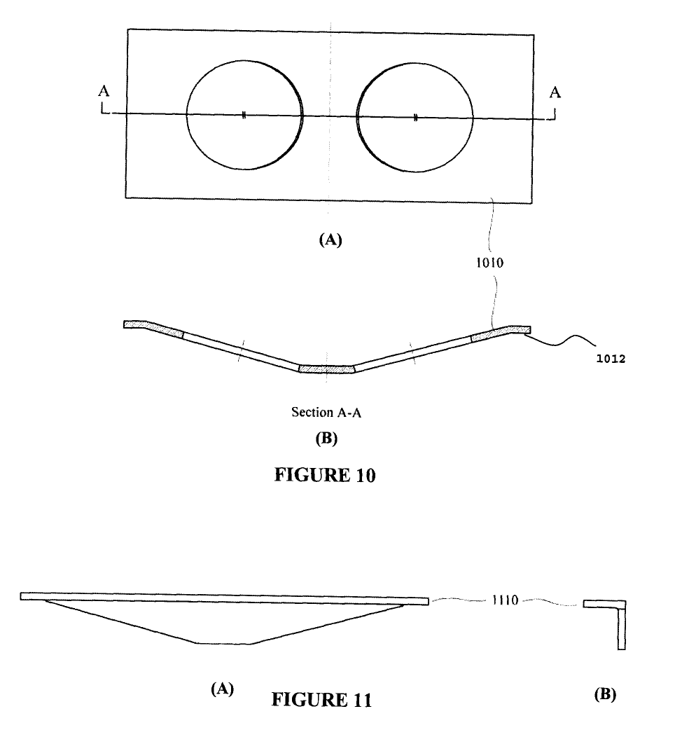

FIGS. 9A, 9B and 9C illustrate a top, a sectional, and a cross sectional view of an inlet section 702 of the two inlet ball check valve illustrated in FIG. 7A. The inlet section 702 comprises a number of components which can be formed, assembled and welded, for example an inlet base element 1010 as illustrated separately in FIGS. 10A and 10B and an inlet side element 1110 as illustrated separately in FIGS. 11A and 11B. The inlet section 702 comprises a mating flange 900 which provides a means for connection of this section to the centre/outlet section 701, thereby forming the housing of the ball check valve 700.

The centre/outlet section 701 and the inlet section 702 can be connected together in such a manner as to enable operation of the ball check valve when a selected internal pressure is generated within the housing. For example, this connection can be selected to meet or exceed ASME standards with an adequate number of bolts or screws, for example. Bolts or screws can be torqued using standard procedures well known to a worker skilled in the art, in order that a predetermined seal and bearing pressure is created between the mating flanges 800 and 900 respectively of the inlet section and the centre/outlet section of the ball check valve 700, thereby creating a selected high-quality even seal. For example, in one embodiment, grade 8 bolts are used to provide a greater seal and coupling strength at the juncture of flanges 800 and 900.

Furthermore, in an embodiment, the housing 705 can be manufactured of a material having mechanical characteristics meeting or exceeding standards established for pressure vessels. For example, the various components of the housing 705, and optionally of the guide rails 730, may be manufactured of a material having a yield strength at least greater or equal to about 355 N/mm², or a tensile strength at least greater or equal to about 510 N/mm², such as boilerplate steel (e.g. SA 516-70) or the like. In another example, these components may be manufactured of a material having a yield strength at least greater or equal to about 375 N/mm², or a tensile strength greater or equal to about 540 N/mm². It will understood by the person skilled in the art that the above figures may vary with temperature and as such, it will be appreciated that the above figures relate to general mechanical characteristics of the materials used in the disclosed embodiment when the valve 700 is operated at standard operation temperatures. A valve 700 designed for operation at high temperatures may thus require that a material be used which exhibits sufficiently high yield and/or tensile strengths at such high temperatures. These and other such embodiments and not considered to depart from the general scope and nature of the present disclosure.

In one embodiment, the housing of valve 700 is manufactured of a material having a yield strength greater or equal to about 355 N/mm². In another embodiment, the housing of valve 700 is manufactured of a material having a yield strength greater or equal to about 375 N/mm². In a further embodiment, the housing of valve 700 is manufactured of a material having a tensile strength greater or equal to about 510 N/mm². In yet another embodiment, the housing of valve 700 is manufactured of a material having a tensile strength greater or equal to about 540 N/mm². For example, the housing wall element 1210, side element 1310, base element 1010 and side element 1110, or a subgroup thereof, may be manufactured of boilerplate steel (e.g. SA 516-70) or the like. Other components of the valve 700 may be manufactured, for example, of various other materials having mechanical characteristics of sufficient strength and quality to meet the operational requirements of the valve 700. For example, in one embodiment, the valve 700 is configured to operate as a pressure vessel and therefore, is constructed to comply with pressure vessel codes and regulations. For example, the valve 700, as described above, may be designed to meet the requirements of ASME BPV Code VIII-1. It will be apparent to the person skilled in the art that the valve 700, as described above, may also meet the requirements of similar codes and standards as defined by different institutions world-wide regulating the fabrication of pressure vessels to be used under conditions contemplated for the above-described valves.

A ball check valve can be used when both of the inlets supply fluid or when the supply of fluid alternates between inlets and it is desired that one inlet closes off as a consequence of the flowing fluid drag from the other inlet. In order to prevent backflow this check valve design requires the static pressure in the outlet to be lower than in at least one inlet. As would be understood by a worker skilled in the art, it is obvious this concept can be applied to multi-ball ball check valves that have N inlets and thus may have N-1 balls positioned therein.

In one embodiment of the ball check valve the distance of the bottom of the guide rail to the bottom of the outlet is about 1.4 times the diameter of the ball. The guide rail is shaped to have a circular circumferential shape and have a radius of about 1.5 to about 2 times the diameter of the ball.

In another embodiment of the ball check valve the angle between the central axis defined by each of the two inlets can range between about 80 degrees and about 120 degrees.

In a further embodiment, the outside of the ball check valve is coated or painted to suppress corrosion with any desired paint, coat or emulsion, for example, 316 stainless steel flake pigment.

Referring now to FIGS. 14A, 14B and 14C a two inlet ball check valve, generally referred to using the numeral 1400 and in accordance with another embodiment of the invention, is illustrated in a top view, a sectional view, and a cross sectional view respectively. The valve 1400 again comprises a housing 1405 defining two inlets 1410, an outlet 1420 and a passageway therebetween. The valve 1400 further comprises an inlet coupling structure 1415 integrally coupled to each of the inlets 1410, each of the inlet coupling structures 1415 illustratively comprising a substantially cylindrical section 1416 and a coupling flange 1411 for coupling the inlet 1410 to a respective inlet pipe or the like (not shown) using a number of appropriately selected bolts, rivets or the like. The valve also further comprises an outlet coupling structure 1418 integrally coupled to the outlet 1420, illustratively comprising a flange 1421 for coupling the outlet 1420 to an outlet pipe or the like (also not shown) using a number of appropriately selected bolts, rivets or the like. In this embodiment, the flanges 1411 and 1421 are illustrated as raised face flanges in order to achieve an improved seal between the respective flange and an adjacent pipe of a network, for example.

In general, the inner surfaces of the housing, the inlet structures 1415 and the outlet structure 1418 are again disposed with liners 1419, the edges of which extending between mating sections of the valve 1400 to provide an enhanced seal therebetween. The liners 1419 may further extend along the annular mating surface of the flanges 1411 and 1421 to enhance a seal between these flanges and the respective flange of an adjacent pipe, for example.

A ball 1435 positioned inside the housing is generally guided by guide rails 1430 which form a portion of the ball support system which can entrain the ball subject to fluid flow and guide the movement of the ball 1435 during operation of the ball check valve 1400. The guide rails 1430 extend all across the width of the interior of the ball check valve 1400 and span proximate to the inside surface near the outlet 1420 to support a laminar flow and suppress the formation of sediment deposits under operation. A liner 1419 may also be disposed on the guide rails 1430.

As above, the guide rails 1430 of the valve's ball support system are generally defined by arcuate guides 1431 inwardly projecting from the housing's side elements 1310 (e.g. see FIG. 13) to define an arcuate path linking the inlets 1410 and reversibly guiding the ball thereon. A corresponding pair of rail support structures 1432 are also provided coupling the arcuate guides 1431 to a structural portion of the housing 1405 angled relative to a plane of the arcuate path defined by the rails 1430, thereby providing radial structural support thereto. Again, as seen in FIG. 14C, the rail support structures 1412 extend divergently toward and are coupled proximal to the outlet 1420 reducing turbulence and sediment build up thereat.

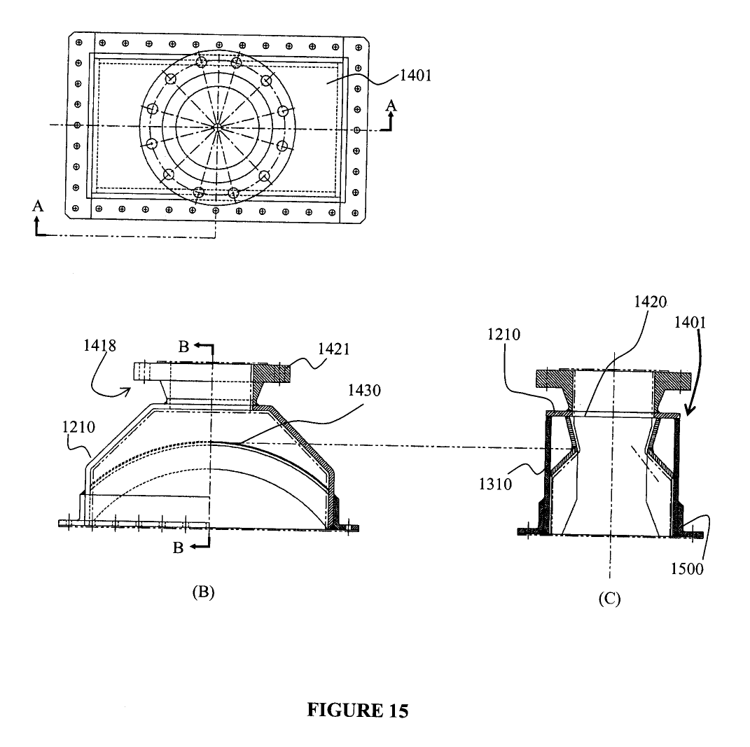

FIGS. 15A, 15B and 15C illustrate a top, a sectional, and a cross sectional view of a housing centre/outlet section 1401 of the two inlet ball check valve illustrated in FIG. 14A. Centre/outlet section 1401 comprises a number of components which are formed, assembled and welded together, for example a housing wall element 1210 as illustrated separately in FIGS. 12A and 12B (i.e. same configuration as for valve 700) and a housing side element 1310 as illustrated separately in FIG. 13 (i.e. same configuration as for valve 700). A mating flange 1500 is illustratively secured to the centre/outlet section 1401 which provides a means for connection of this section to the housing inlet section 1402, thereby forming the housing 1405 of the ball check valve 1400.

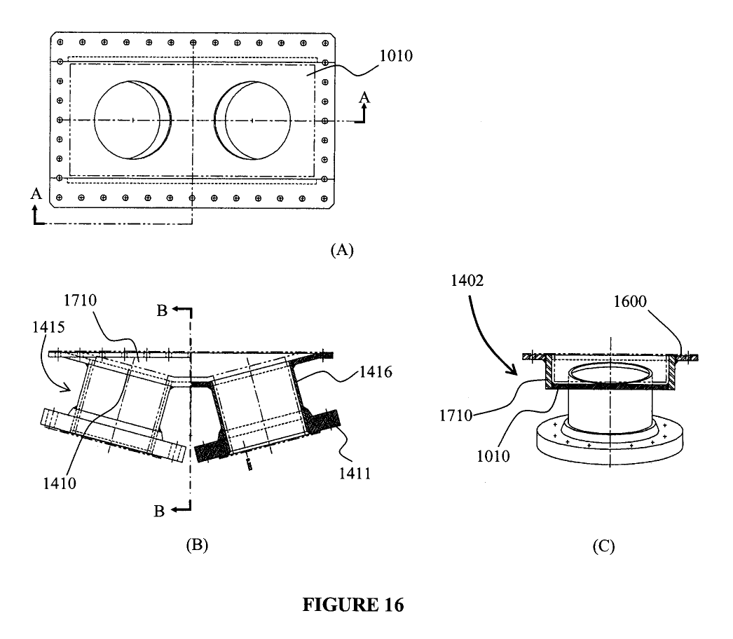

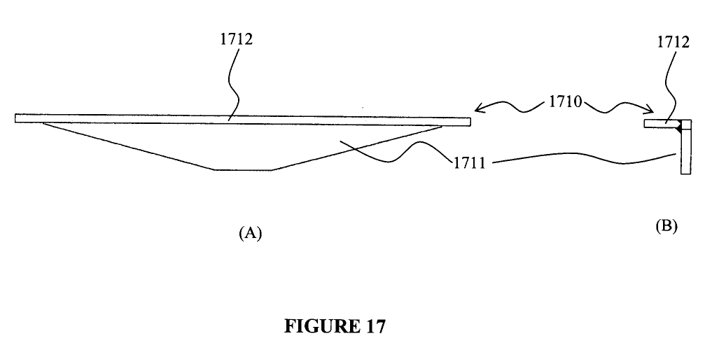

FIGS. 16A, 16B and 16C illustrate a top, a sectional, and a cross sectional view of a housing inlet section 1402 of the two inlet ball check valve 1400 illustrated in FIG. 14A. The inlet section 1402 comprises a number of housing components which can be formed, assembled and welded, for example a housing base element 1010 as illustrated separately in FIGS. 10A and 10B (i.e. same configuration as for valve 700) and a housing side element 1710 as illustrated separately in FIGS. 17A and 17B. Note that the inlet side element 1710 differs from its counterpart 1110 by using a side element 1711 welded to an outwardly projecting flange member 1712 rather than a single angled member, for example, when a single angled member is not available in a particular housing material preferred for achieving a given set of structural requirements. A mating flange 1600 (illustratively defined by flange member 1712 and an edge portion 1012 of housing base element 1010) is provided on the centre/outlet section 1401 which provides a means for connection of this section to the housing inlet section 1402, thereby forming the housing 1405 of the ball check valve 1400.

The centre/outlet section 1401 and the inlet section 1402 can be connected together in such a manner as to enable operation of the ball check valve when a selected internal pressure is generated within the housing. For example, this connection can be selected to meet or exceed ASME standards with an adequate number of bolts or screws, for example. Bolts or screws can be torqued using standard procedures well known to a worker skilled in the art, in order that a predetermined seal and bearing pressure is created between the mating flanges 1500 and 1600 respectively of the inlet section and the centre/outlet section of the ball check valve 1400, thereby creating a selected high-quality even seal. For example, in one embodiment, grade 8 bolts are used to provide a greater seal and coupling strength at the juncture of flanges 1500 and 1600.

Furthermore, in an embodiment, the housing 1405 can be manufactured of a material having mechanical characteristics meeting or exceeding standards established for pressure vessels. For example, the various components of the housing 1405, and optionally of the guide rails 1430, may be manufactured of a material having a yield strength at least greater or equal to about 355 N/mm², or a tensile strength at least greater or equal to about 510 N/mm², such as boilerplate steel (e.g. SA 516-70) or the like. In another example, these components may be manufactured of a material having a yield strength at least greater or equal to about 375 N/mm², or a tensile strength greater or equal to about 540 N/mm². It will understood by the person skilled in the art that the above figures may vary with temperature and as such, it will be appreciated that the above figures relate to general mechanical characteristics of the materials used in the disclosed embodiment when the valve 1400 is operated at standard operation temperatures. A valve 1400 designed for operation at high temperatures may thus require that a material be used which exhibits sufficiently high yield and/or tensile strengths at such high temperatures. These and other such embodiments and not considered to depart from the general scope and nature of the present disclosure.

In a further embodiment, the housing of valve 1400 is manufactured of a material having a yield strength greater or equal to about 355 N/mm². In another embodiment, the housing of valve 1400 is manufactured of a material having a yield strength greater or equal to about 375 N/mm². In a further embodiment, the housing of valve 1400 is manufactured of a material having a tensile strength greater or equal to about 510 N/mm². In yet another embodiment, the housing of valve 1400 is manufactured of a material having a tensile strength greater or equal to about 540 N/mm². For example, the housing wall element 1210, side element 1310, base element 1010 and side element 1710 may be manufactured of boilerplate steel (e.g. SA 516-70) or the like. Other components of the valve 1400 may be manufactured, for example, of various other materials having mechanical characteristics of sufficient strength and quality to meet the operational requirements of the valve 1400. For example, cylindrical sections 1416 may be manufactured of SA 106-C pipe or the like, flanges 1411 and 1418 may comprise SA 105 RF flanges or the like and flanges 1500 may be manufactured of SA/CSA-G40.21-38W angle steel or the like. Using the above exemplary materials for an 8 inch valve, finite element analysis of the valve integrity at a temperature of about 100° F. and a pressure of about 300 psi confirms that the valve 1400 complies with pressure vessel codes and regulations. For example, the valve 1400, as described above, meets the requirements of ASME BPV Code VIII-1 Ed. 2005+A05.

It will be apparent to the person skilled in the art that the valve 1400, as described above, may also meet the requirements of similar codes and standards as defined by different institutions world-wide regulating the fabrication of pressure vessels to be used under conditions contemplated for the above-described valves.

Variations to the above description of valve 1400, whether in material, in size and/or in method of manufacture, should now be apparent to the person of skill in the art to modify the valve while still meeting the requirements of pressure vessel codes. For example, a similar construction may be considered for a valve operating at 150 psi rather than 300 psi, the former possibly being constructed of lower grade inlet and outlet flange structures to reduce costs while maintains sufficient structural and coupling integrity to operate at a lower pressure. Similar constructions for valves of various sizes smaller or larger than the 8 inch valve tested above may also be considered within the scope of the present disclosure. In addition, the use of a higher grade steel to construct a single of multiple inlet valve, as described above, which exhibits mechanical properties greater than that of boilerplate steel (e.g. SA516-70) can also be considered herein to achieve similar results. Furthermore, parts described herein as not manufactured of boilerplate steel, may nonetheless be manufactured as such within the context of the present disclosure to meet the above requirements.

It will also be appreciated by the person skilled in that art that, although the above illustrative embodiments of the invention are described to provide a single outlet coupling to a downstream outlet pipe, in other embodiments of single or multiple inlet valves, the outlet may be configured to connect to two or more outlet pipes, i.e. the fluid flow from the one or more open inlets exits the outlet to two or more outlet pipes. The outlet section in such embodiments can be integrally formed with the rest of the housing or individually fabricated and then assembled with the other sections to form the housing. Similarly, the outlet itself could be formed of individual sections which, when assembled, are functional to connect to two or more outlet pipes

It will be apparent to the person skilled in the art that the above-described embodiments of the invention are exemplary and can be varied in many ways. Such variations are not to be regarded as a departure from the spirit and scope of the invention, and all such variations, as would be apparent in the art, are intended to be included within the scope of the following claims.

I claim:

1. A ball check valve for enabling conveyance of a fluid through the ball check valve, the ball check valve comprising:
a housing defining one or more inlets, an outlet and a passageway therebetween, a ball seat being defined at each of said one or more inlets;
a ball support system positioned within said housing; and
a ball reversibly moveable between two or more positions along said ball support system, a first of said positions being proximal to said ball seat defined at a given one of said one or more inlets wherein said ball mates with this ball seat to close said given inlet impeding fluid flow therethrough, a second of said positions being distant from said given inlet wherein fluid flow between the given inlet and the outlet is enabled;
wherein the ball check valve is configured as a pressure vessel.

2. The ball check valve as claimed in claim 1, the ball check valve comprising two or more inlets, said first position being proximal to the ball seat defined at a first of said two or more inlets and said second position being proximal to the ball seat defined at a second of said two or more inlets, said ball support system further comprising a pair of arcuate guide rails inwardly projecting from said housing to define an arcuate path linking said inlets and reversibly guiding said ball thereon between said first position and said second position, a corresponding pair of rail support structures coupling said guide rails to a structural portion of said housing angled relative to a plane defined by said arcuate path to provide at least partial radial structural support thereto.

3. The ball check valve as claimed in claim 2, said rail support structures being coupled to said housing and extending divergently toward and coupled proximate to said outlet to reduce turbulence and sediment build up thereat.

4. The ball check valve as claimed in claim 1, said housing being manufactured of a material having a yield strength of at least about 355 N/mm² and a tensile strength of at least about 510 N/mm².

5. The ball check valve as claimed in claim 4, wherein said material comprises a boilerplate steel.

6. The ball check valve as claimed in claim 5, wherein material characteristics of said boilerplate steel are compliant with ASTM 516 Grade 70 steel.

7. The ball check valve as claimed in claim 4, wherein said ball support system is manufactured of said material.

8. The ball check valve as claimed in claim 4, wherein said housing is manufactured of a plurality of sections welded according to ASME standards with one or more of SFA 5.18 class E70C-6M-H4 and FCAW E4801T-9-CH electrodes.

9. The ball check valve as claimed in claim 1, the valve further comprising an inlet coupling structure integrally coupled to said housing at each of said one or more inlets, each of said inlet coupling structures comprising a raised face flange for sealingly coupling said one or more inlets to a respective inlet pipe.

10. The ball check valve as claimed in claim 1, the valve further comprising an outlet coupling structure integrally coupled to said housing at said outlet, said outlet coupling structure comprising one or more raised face flanges for sealingly coupling said outlet to one or more respective outlet pipes.

11. The ball check valve as claimed in claim 1, wherein a hardness of said ball is at least about 70% greater than that of each said ball seat.

12. The ball check valve as claimed in claim 11, wherein said hardness of said ball is at least 100% greater than that of each said ball seat.

13. The ball check valve as claimed in claim 11, wherein each said ball seat is covered by a liner, said hardness of said ball seat being defined by a hardness of said liner.

14. The ball check valve as claimed in claim 11, said ball comprising an inner core and an outer cover, a hardness of said ball being defined by a hardness of said outer cover.

15. The ball check valve as claimed in claim 1, said ball support system comprising one or more ball support elements disposed in a bottom region of said housing for supporting said ball thereon, said one or more ball support elements comprising a substantially horizontal portion proximal to the ball seat for supporting said ball when in said first position, an upwardly arcuate portion defining a ball stop for restricting travel of said ball away from said first position, and a step portion therebetween for urging said ball toward said first position against said fluid flow.

16. The ball check valve as claimed in claim 15, said ball support system further comprising a liner disposed over said ball support structure, a thickness of said liner being greater in a region of said step portion to mitigate increased impact of said ball in this region.

17. The ball check valve as claimed in claim 1, wherein the valve is constructed in accordance with ASME BPV Code VIII-1.

18. The ball check valve as claimed in claim 1, wherein the valve is constructed to withstand an operating pressure of at least about 300 psi at an operating temperature of at least about 100 K.

19. A ball check valve for enabling conveyance of a fluid through the ball check valve, the ball check valve comprising:
a housing defining one or more inlets, an outlet and a passageway therebetween, a ball seat being defined at each of said one or more inlets;
a ball support system positioned within the housing; and
a ball reversibly moveable between two or more positions along the ball support system, a first of said positions being proximal to the ball seat defined at a given one of said one or more inlets wherein the ball mates with this ball seat to close said given inlet impeding fluid flow therethrough, a second of said positions being distant from the given inlet wherein fluid flow between the given inlet and the outlet is enabled;
wherein a hardness of said ball is at least about 70% greater than that of each said ball seat.

20. The ball check valve as claimed in claim 19, wherein said hardness of said ball is at least about 100% greater than that of each said ball seat.

21. The ball check valve as claimed in claim 19, wherein each said ball seat is covered by a liner, said hardness of said ball seat being defined by a hardness of said liner.

22. The ball check valve as claimed in claim 19, said ball comprising an inner core and an outer cover, a hardness of said ball being defined by a hardness of said outer cover.

23. The ball check valve as claimed in claim 1, wherein said outlet is configured to couple to two or more outlet pipes.
